(19) United States
(12) Patent Application Publication
(10) Pub. No.: US 2005/0016570 A1
(43) Pub. Date: Jan. 27, 2005

(54) Machines for washing mops and integrated devices having a pulsator and a water removal barrel thereof

(76) Inventors: Jihai Xu, Guangdong Province (CN); Changan Wang, Guangdong Province (CN)

Correspondence Address: NORRIS, MCLAUGHLIN & MARCUS, P.A., 875 THIRD AVE, 18TH FLOOR, NEW YORK, NY, 10022, US

(21) Appl. No.: 10/476,781

(22) PCT Filed: May 8, 2002
(86) PCT No.: PCT/CN02/00309

(30) Foreign Application Priority Data
May 8, 2001 (CN) 01225912.8
Jun. 20, 2001 (CN) 01229933.2
Jul. 18, 2001 (CN) 01241855.2

(51) Int. Cl. B08B 3/00

(52) U.S. Cl. 134/140; 134/186; 134/157; 134/188

(57) ABSTRACT

The invention provides a machine for washing a mop, which includes a housing, a driving mechanism, a controlling mechanism, a pulsator, a water tank, a water removal barrel, a draining mechanism, and a mop supporting means, wherein an integrated device of the pulsator and the water removal barrel consists of the water removal barrel which is a cylinder without bottoms and the pulsator which is fixed together with the lower end of the barrel. The mop supporting means is a protrusion supporting element which is on the upper end of the center of the pulsator.

### FIELD OF THE INVENTION

The present invention relates to a machine for washing a mop and an integrated device having a pulsator and a water removal barrel used in the machine. The machine of the invention is used for washing a mop and removing water from the same.

### BACKGROUND OF THE INVENTION

The mop washing machine of prior art is based on a single-tub automatic washing machine and further includes a mop supporting device. The mop washing machine in the art generally includes a housing, a driving mechanism, a controlling mechanism, a washing tank, a water removal barrel, a draining mechanism, and a mop supporting device. Some of them further include a pulsator and a water input mechanism. However, such machines have following disadvantages: (1) The cost of manufacturing is higher because they comprise excess elements and have a complicated structure of the mop supporting device. (2) It is difficult to move them because they generally have a larger size. (3) They can only be used for specific mops.

### SUMMARY OF THE INVENTION

Accordingly, in order to overcome the above-mentioned problems of prior art, an object of the present invention is to provide a mop washing machine having a simple structure, a smaller size and good washing effect.

In order to achieve the above-mentioned object, the present invention provides a mop washing machine comprising a housing, a driving mechanism, a controlling mechanism, a pulsator, a water tank, a water removal barrel, a draining mechanism, and a mop supporting element, wherein the water removal barrel is a hollow cylinder without bottoms, the lower end of which is connected with the pulsator to constitute an integrated device of the pulsator and the water removal barrel.

In use, a mop is supported on the mop supporting element to make a cleaning cloth of the mop head put into the integrated device of the pulsator and the water removal barrel. Turning on the switch, the cleaning cloth of the mop is washed by making the integrated device of the pulsator and the water removal barrel rotate so as to form a rotatable water flow. After the cleaning cloth has been washed, the integrated device of the pulsator and the water removal barrel rotates at a higher speed in order to remove water form the mop. The cleaning cloth of the mop attaches the inner wall of the water removal barrel because of the centrifugal force. Thus, the mop is dried.

In order to achieve the above-mentioned object, the present invention provides another mop washing machine comprising a housing, a driving mechanism, a controlling mechanism, a pulsator, a washing barrel, a water removal barrel, a draining mechanism, and mop supporting means, wherein an integrated device of the pulsator and the water removal barrel is constituted by integrating the pulsator used as the barrel bottom with a wall of the water removal barrel having a plurality of water removal holes, and the output shaft of the driving mechanism including an asynchronous motor and a reduction mechanism with first class strap wheel is connected with the pulsator.

The output rotate speed of the driving mechanism may be 350˜600 rpm, optimally 400˜550 rpm. The driving mechanism includes a motor and a reduction mechanism with a first class strap wheel.

The water flow resistance can be increased if the height is excess. The water removal barrel in the integrated device of the pulsator and the water removal barrel has a height of 50˜300 mm, optimally 100˜250 mm.

In one embodiment of the present invention, the water removal barrel in the integrated device of the pulsator and the water removal barrel has a diameter of at least more than Φ150 mm, optimally Φ200˜350 mm.

The reason why the water removal barrel in the integrated device of the pulsator and the water removal barrel has a diameter of at least more than Φ150 mm is that it is necessary to have a higher rotation speed if the diameter is smaller, or else the water remove effect is not met. However, the higher the rotate speed is, the stronger the libration of the machine is. The diameter should not be too small, the optimum diameter is Φ200˜350 mm.

In another embodiment of the present invention, the housing consists of an upper portion, a lower portion, wherein the upper portion is integrated with the water tank to constitute a body of the washing barrel, and the lower portion constitutes a pedestal to retain a motor, a transmission mechanism and the draining mechanism. Thus, the structure can be simplified.

In another embodiment of the present invention, the mop supporting means is a protrusion supporting element located at the upper center of the pulsator.

The mop supporting means may be a protrusion supporting element located at the upper center of the pulsator for supporting the lower end of the lower supporting head. In use, the mop is put into the washing barrel filled with water. The lower supporting head is supported on the supporting element to make the cleaning cloth of the mop head put into the integrated device of the pulsator and the water removal barrel. When the pulsator rotates, the mop doesn't rotate because the central axis of the pulsator is fixed. Thus, the upper portion of the mop can rotate freely. Therefore, when the pulsator rotates, the washing process can be achieved by controlling the upper portion of the mop to support the mop on the supporting element by hand.

The mop supporting means located at the upper end of the pulsator has a supporting point for engaging the lower supporting head of the mop. The point may be designed as a recess or a convex in the shape of a cone, a cylinder, a sphere, or a combination thereof to match a lower supportive head of the mop.

In another embodiment of the present invention, the pulsator is a pulsator having a higher supportive rod. The supporting element is mounted on the upper end of the supportive rod to constitute a combined pulsator.

In another embodiment of the present invention, the supporting element the mop supporting means that is located at the upper end of the pulsator further comprises an upper bracket fixed on the top end of the housing and an upper locating element corresponding to the mop supporting element for locating the upper portion of the mop.

In a further embodiment of the present invention, the upper bracket is formed in the shape of a door frame, and the upper locating element is disposed at the lower surface of the upper crossbeam of the upper bracket including a locating body having a spherical recess locating point provided at the lower end surface thereof, a spring, and an installation base. The locating body is in the shape of a mushroom with a mushroom head having a larger diameter at the lower portion thereof and a shaft having a smaller diameter at the upper portion thereof and mounted on the installation base with one end thereof, and the spring encompasses the shaft of the locating body. Alternatively, the upper bracket consists of two cover boards, and the upper locating element can be opened or closed and has a through hole formed on the center of the two cover boards. The upper bracket may be a triangular-shaped bracket, and the upper locating element has an integral cylindric configuration.

The present invention also provides an integrated device of the pulsator and the water removal barrel used in the mop washing machine. The integrated device of the pulsator and the water removal barrel is constituted by connecting the wall of the water removal barrel which has a plurality of water removal holes and is disposed on the pulsator to the pulsator that forms the barrel bottom.

### BRIEF DESCRIPTION OF THE DRAWINGS

The present invention will be further described below with reference to the drawings, in which:

FIG. 1 is a front section view of one embodiment of the present invention;

FIG. 2 is a partially enlarged view of an upper locating element of an embodiment of the present invention;

FIG. 3 is a front section view of another embodiment of the present invention;

FIG. 4 is a top view of the embodiment as shown in FIG. 3;

FIG. 5 is a front section view of another embodiment of the present invention;

FIG. 6 is a top view of the embodiment as shown in FIG. 5;

FIG. 7 is a front section view of another embodiment of the present invention;

FIG. 8 is a front section view of another embodiment of the present invention;

FIG. 9 is a partially enlarged view of the embodiment as shown in FIG. 8;

FIG. 9 is a front section view of an integrated device of the pulsator and the water removal barrel used in the mop washing machine of the present invention;

FIG. 10 shows another embodiment of the integrated device of the pulsator and the water removal barrel as shown in FIG. 10;

FIG. 11 shows another embodiment of the integrated device of the pulsator and the water removal barrel of the present invention;

FIG. 12 shows another embodiment of the integrated device of the pulsator and the water removal barrel of the present invention;

FIG. 13 shows another embodiment of the integrated device of the pulsator and the water removal barrel of the present invention;

FIG. 14 shows another embodiment of the integrated device of the pulsator and the water removal barrel of the present invention;

FIG. 15 shows another embodiment of the integrated device of the pulsator and the water removal barrel of the present invention; and

FIG. 16 shows another embodiment of the integrated device of the pulsator and the water removal barrel of the present invention.

### DETAILED DESCRIPTION OF PREFERRED EMBODIMENTS OF THE INVENTION

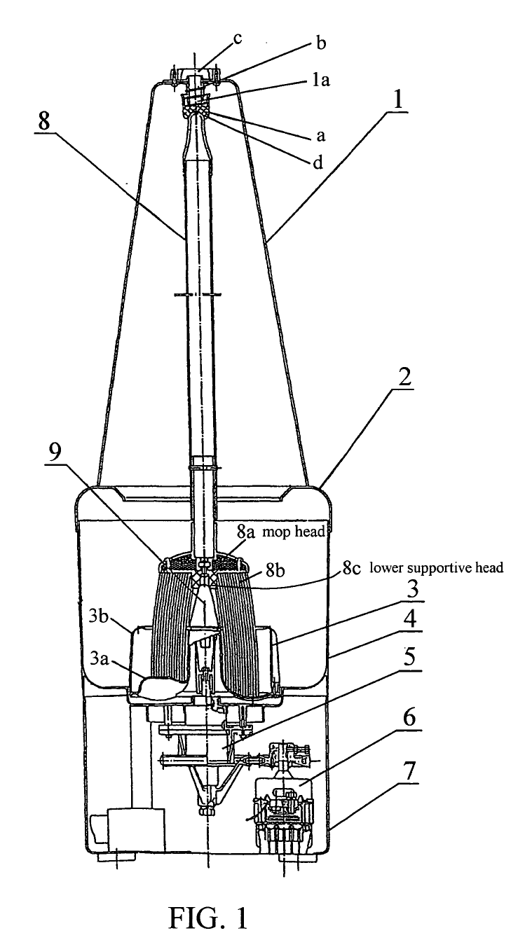

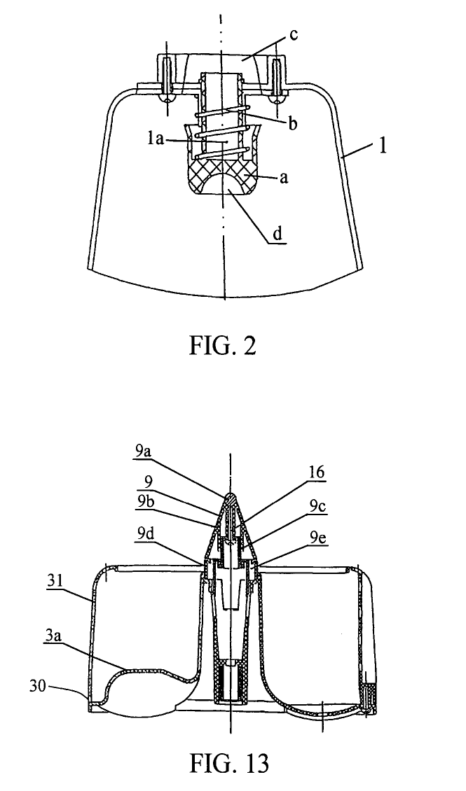

FIG. 1 show one embodiment of a mop washing machine of the present invention, which includes a housing, a driving mechanism, a controlling mechanism, a pulsator 3a, a water tank, a water removal barrel 3b, a draining mechanism, and mop supporting means. The housing consists of an upper portion (a washing barrel body) 4, and a lower portion (a pedestal) 7 and a top cover 2. The upper portion is integrated with the water tank to be the washing barrel body 4, and the lower portion forms the pedestal 7. The driving mechanism and the draining mechanism are disposed within the pedestal 7. The driving mechanism includes an asynchronous motor 6 and a transmission mechanism 5 that may be a reduction mechanism with a first class strap wheel to drive the mop washing machine. The water removal barrel 3b is designed to be a cylinder without bottoms having a diameter of at least more than Φ150 mm and a height of 50˜300 mm. The optimum diameter is Φ200˜350 mm (in this embodiment being 250 mm). The optimum height is 100˜250 mm (in this embodiment being 180 mm). The lower end of the water removal barrel is connected to the pulsator 3a, which is a pulsator having a higher supportive rod in this embodiment, via bolts to form an integrated device of the pulsator and the water removal barrel. The mop supporting means includes a mop supporting element 9 above the pulsator, an upper bracket 1 which has a door frame shape and is fixed on the top cover 2 of the housing, and an upper locating element 1a. The mop supporting element 9 has the shape of a cone with a spherical top portion, and is disposed at the upper end of the pulsator. Correspondingly, a lower supporting head 8c of a mop 8 is provided at the lower end of a mop head 8a of the mop, which has a spherical recess disposed at the lower end thereof to receive the spherical top portion of the mop supporting element 9. The upper locating element 1a for locating the upper portion of the mop which is disposed at the lower surface of an upper crossbeam of the upper bracket 1 and coaxial with the mop supporting element 9 includes a locating body a having a spherical recess locating point d provided at the lower end surface thereof, a spring b and an installation base c (as shown in FIG. 2). The locating body a has the shape of a reverse mushroom with a mushroom head having a larger diameter disposed at a lower portion thereof and a shaft having a smaller diameter disposed at an upper portion thereof and being mounted on the installation base c with one end thereof. The spring b encompasses the shaft of the locating body a. After the lower supporting head of the mop head has been mounted on the mop supporting element 9, the upper end of the handle of the mop is put into the locating point d of the upper locating element to fix the mop into the washing barrel.

In use, the mop is put into the washing barrel filled with water. The lower supporting head 8c is supported on the mop supporting element 9 to make the cleaning cloth 8b of the mop put into the integrated device of the pulsator and the water removal barrel 3. Then, the upper end of the handle of the mop is put into the locating point d of the upper locating element to fix the mop in the washing barrel. Turning on the switch, the washing process is performed firstly by making the integrated device of the pulsator and the water removal barrel 3 rotate clockwise and anticlockwise so as to form a rotatable water flow to wash the cleaning cloth of the mop. After the cleaning cloth has been washed, the integrated device of the pulsator and the water removal barrel rotates at a higher speed in one direction to remove water from the mop. After the mop has been dried, the mop can be taken out by releasing the upper locating element 1a.

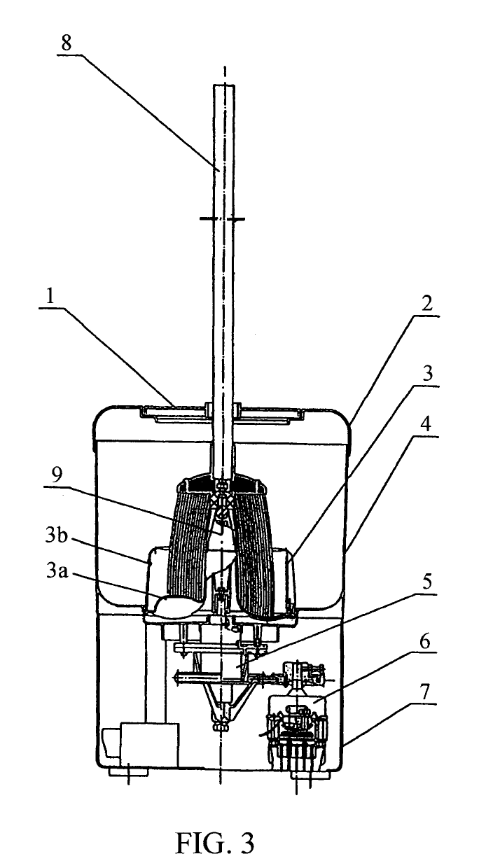

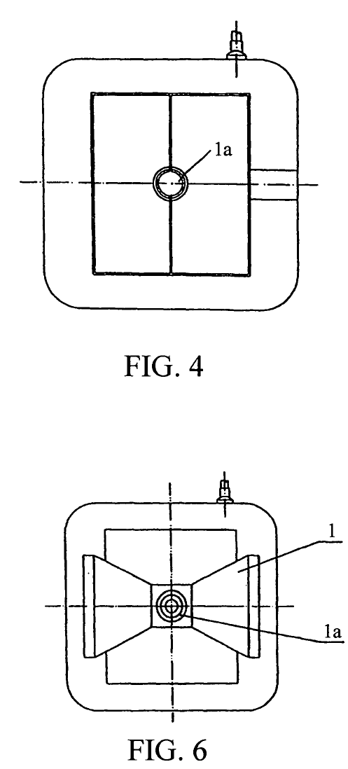

The mop washing machine as shown in FIGS. 3 and 4 is another embodiment the present invention. The present embodiment is similar to the above embodiment except the following aspects. The water removal barrel 3b in the integrated device of the pulsator and the water removal barrel 3 has a diameter of 300 mm and a height of 250 mm. The upper bracket 1 of the mop supporting means consists of two cover boards of the mop washing machine. The upper locating element 1a can be opened or closed and has a through hole formed at the center of the connection of the two cover boards. In use, after the two cover boards are opened, the mop head 8a can be put into the integrated device of the pulsator and the water removal barrel 3. Thereafter, the two cover boards are closed to make the mop handle place into the through hole for fixing the mop. Then, the washing process can be initiated.

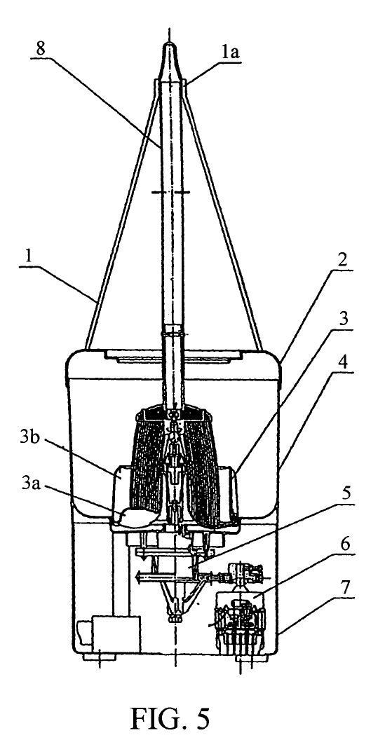

The mop washing machine as shown in FIGS. 5 and 6 is another embodiment of the present invention. The present embodiment is similar to the above embodiment except the following aspects. The water removal barrel 3b in the integrated device of the pulsator and the water removal barrel 3 has a diameter of 350 mm and a height of 280 mm. The upper bracket 1 of the mop supporting means is a triangular-shaped bracket. The upper locating element 1a has an integral cylindric configuration. In use, the upper portion of the mop handle passes through the upper locating element 1a firstly, then the lower end of the mop head is mounted on the mop supporting element 9 located on the pulsator. Thus, the mop can be fixed in the washing barrel.

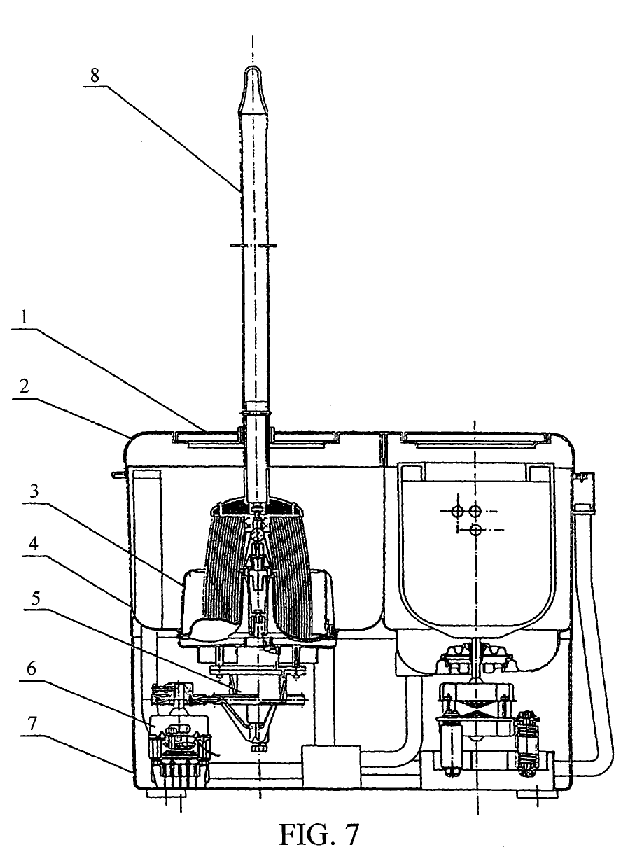

The mop washing machine as shown in FIG. 7 is another embodiment of the present invention, which includes a housing, a driving mechanism, a controlling mechanism, a pulsator, a water tank, a water removal barrel, a draining mechanism, and mop supporting means. An integrated device of the pulsator and the water removal barrel is constituted by integrating the pulsator as the barrel bottom with the wall of the water removal barrel having a plurality of water removal holes. An output shaft of the driving mechanism is connected with the pulsator in order to drive the integrated device of the pulsator and the water removal barrel via an asynchronous motor disposed within the driving mechanism. The mop washing machine of the present embodiment has a double-barrel configuration. That is, a washing barrel is disposed at the right side to wash the mop, and a water removal barrel is disposed at the left side to remove water and includes the integrated device of the pulsator and the water removal barrel and the mop supporting means to remove water from the mop. The mop can be washed in the washing barrel and be dried in the water removal barrel by means of the double-barrel configuration. Thus, the washing water does not need to be refreshed until washing performance has undergone several times. As a result, the mop washing machine can be used easily and not limited to be used at certain place where the water can be refreshed easily such as rest rooms.

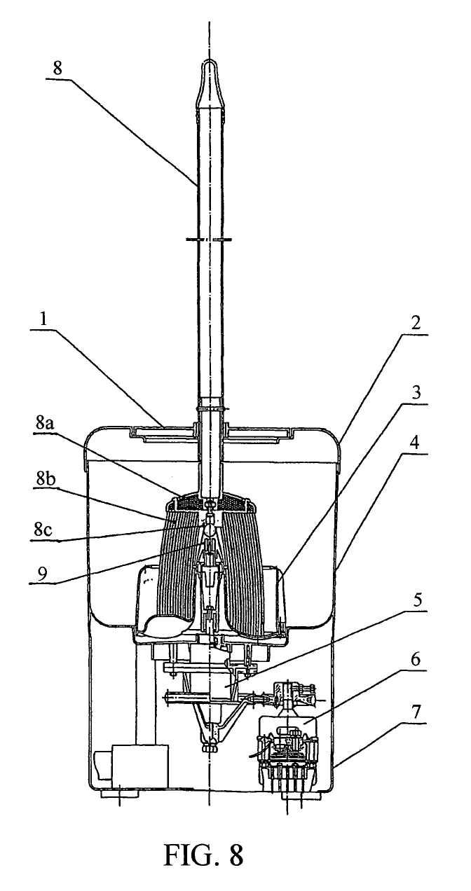

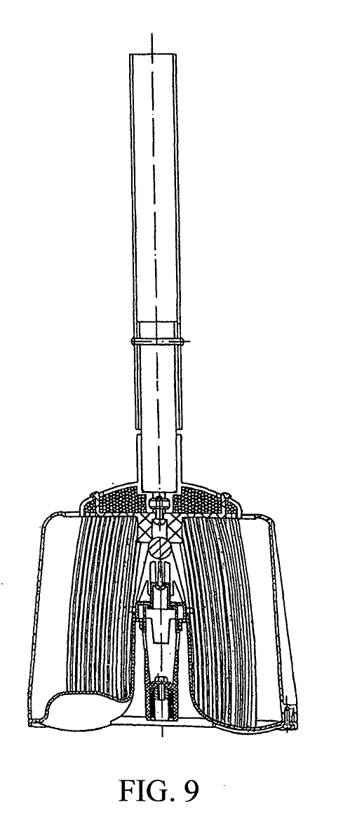

In order to achieve the above-mentioned object, another embodiment of the mop washing machine of the present invention is shown in FIGS. 8 and 9. The mop washing machine of the present embodiment includes a housing, a driving mechanism, a controlling mechanism, a water tank, an integrated device of the pulsator and the water removal barrel, a draining mechanism, and a mop supporting means. The housing consists of an upper portion, a lower portion and a top cover 2. The upper portion is integral with the water tank to constitute a washing barrel body 4, and the lower portion constitutes a pedestal 7. The driving mechanism together with the draining mechanism is disposed within the pedestal 7 and includes an asynchronous motor 6, a transmission mechanism with a first class strap wheel 5. The water removal barrel has a wall with a plurality of holes that allow water passing through and has a diameter of at least more than Φ150 mm and a height of 50˜300 mm. The optimum diameter is Φ200˜350 mm (in this embodiment the diameter being 250 mm), and the optimum height is 100˜250 mm (in this embodiment the height being 180 mm). The lower end of the water removal barrel is connected to the pulsator 3a via bolts to constitute an integrated device of the pulsator and the water removal barrel. The pulsator is a pulsator having a higher supportive rod that is used as the bottom of the water removal barrel. The mop supporting means includes a mop supporting element 9 which has a cone structure with a spherical top portion and is located at the upper end of the pulsator. Correspondingly, a lower supporting head 8c is provided at the lower end of the mop head 8a, which has a spherical recess disposed at the lower end thereof to receive the spherical top portion of the mop supporting element 9.

In use, the mop is put into the mop washing machine filled with water. The lower supporting head 8c is mounted on the mop supporting element 9 to make the cleaning cloth 8b put into the integrated device of the pulsator and the water removal barrel 3. Then, one can support the upper end of the mop handle by hand. Turning on the switch, the washing process is performed firstly by making the integrated device of the pulsator, and the water removal barrel 3 rotates clockwise and anticlockwise so as to form rotatable water flow to wash the cleaning cloth of the mop. After the cleaning cloth has been washed, since the water tank is empty, there is no water resistance to the integrated device of the pulsator and the water removal barrel. As a result, although the rotate speed of the driving mechanism is the same as the washing process, a higher speed in one direction than the washing process is available, thereby removing water from the mop. After the mop has been dried, it can be taken out as above.

Because the asynchronous motor used provides the same rotate speed of the driving mechanism in the washing process as in the water removal process, it is necessary to control the rotate speed to meet requirements both in the washing process and the waste water removal process. The rotate speed of the driving mechanism may be at 350˜600 rpm, optimally at 400˜550 rpm.

In order to further simplify the mop washing machine, a reducer of the driving mechanism can be omitted. That is, the driving mechanism only consists of an asynchronous motor and a first class reduction mechanism which may be a first class strap wheel.

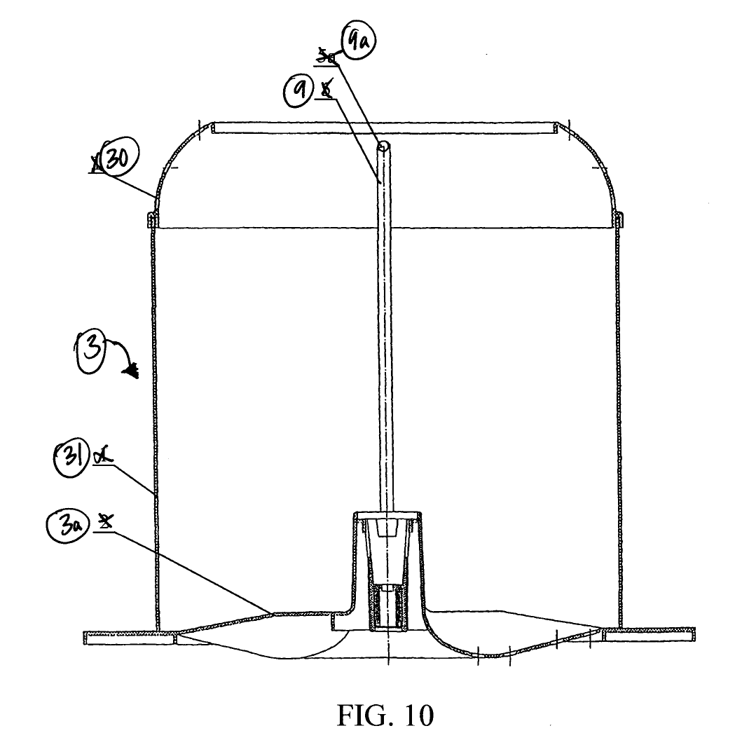

FIG. 10 shows an integrated device of the pulsator and the water removal barrel that is used in the mop washing machine of the present invention. The integrated device of the pulsator and the water removal barrel is constituted by connecting the lower end of the wall 1 of the water removal barrel which has a plurality of water removal holes 30 to the pulsator 2 (as the barrel bottom) via bolts. The water removal barrel wall 1 has a diameter of more than Φ150 mm and a height of 50˜300 mm. The optimum diameter is Φ200˜350 mm (in this embodiment the diameter being 150 mm) and less than the diameter of the pulsator. The optimum height is 100˜250 mm (in this embodiment the height being 180 mm). A protrusion supporting element made of metals 5 having a supporting sphere 5a disposed at the upper end thereof to support the lower supporting head of the mop is extended upward from the center of the pulsator 2, the height of which is slightly higher than the upper edge of the wall 1.

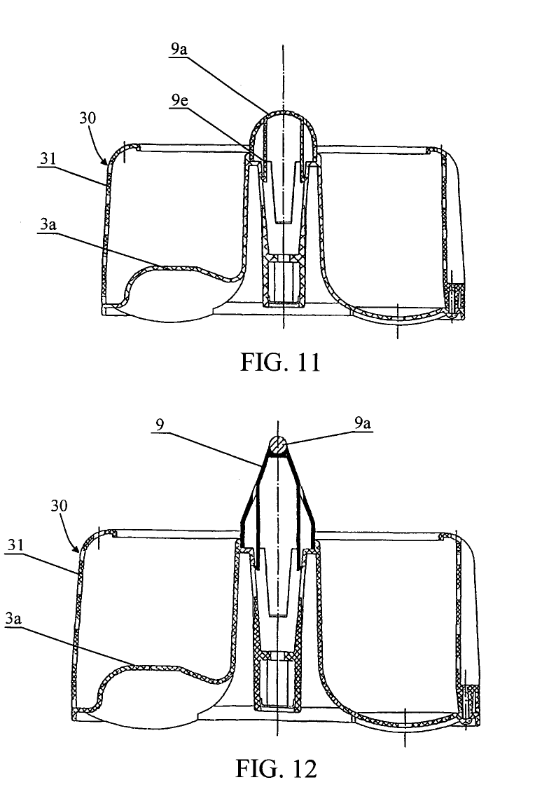

The structure as shown in FIG. 11 is a variation of the above embodiment of the above-mentioned integrated device of the pulsator and the water removal barrel. The present embodiment is similar to the above embodiment except the following aspects. The pulsator 2 is a pulsator having a higher supportive rod. The supporting element 5 is located at the upper end of the central cylinder of the pulsator and is connected to the pulsator 2 via bolts, and has four hooks 4 extended downward from the lower end for connecting the supportive rod of the pulsator. A hemisphere is provided at the upper end to match the lower supporting head of the mop. The wall 1 of the water removal barrel has a diameter of 300 mm slightly larger than the pulsator and a height of 250 mm.

The structure as shown in FIG. 12 is a variation of the embodiment of the above-mentioned integrated device of the pulsator and the water removal barrel. The present embodiment is similar to the above embodiment except the following aspect. The wall 1 of the water removal barrel has a diameter of 350 mm and a height of 280 mm. The supporting element 5 has a cone structure having a supporting point 5a disposed at the upper end thereof, and is made of stainless steel in order to improve its antiwear and its life.

Correspondingly, a lower supporting head of the mop provides a spherical recess to engage the supporting point 5a of the supporting element.

The structure as shown in FIG. 13 is a variation of the embodiment of the integrated device of the pulsator and the water removal barrel. The present embodiment is similar to the above embodiment except the following aspects. The supporting element 5 located at the upper end of the pulsator consists of a supporting body 5b, a base 5d and a rotatable element 5c. The supporting body 5b has a cone structure having a supporting point 5a disposed at the upper end thereof, the lower end of which is connected with the upper end of the rotatable element 5c via bolts 6. The lower edge of the rotatable element 5c has a larger diameter and can be mounted within a rotatable hole provided at the upper end of the base 5d. Four downward hooks 4 are disposed at the lower end of the base 5d for connecting the pulsator. When the pulsator rotates, the base 5d is driven to rotate, but the rotatable element 5c and the supporting body 5b can be immoblile. That is, when the lower supporting head engages the supporting element, there is no relative movement between the lower supporting head and the supporting body to avoid friction therebetween, but a relative movement between the rotatable element and the base.

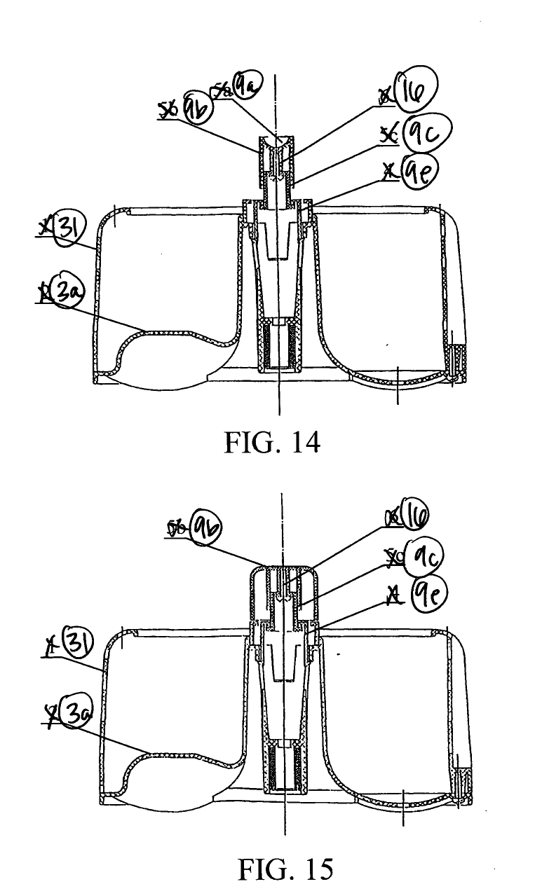

The structure as shown in FIG. 14 is a variation of the embodiment of the integrated device of the pulsator and the water removal barrel. The present embodiment is similar to the above embodiment except that the supporting body 5b has a cylinder-shaped structure, and the supporting point 5b is a hemispherical recess.

The structure as shown in FIG. 15 is a further variation of the embodiment of the integrated device of the pulsator and the water removal barrel. The present embodiment is similar to the above embodiment except that the supporting body 5b is a cylinder shape structure and designed as the supporting point.

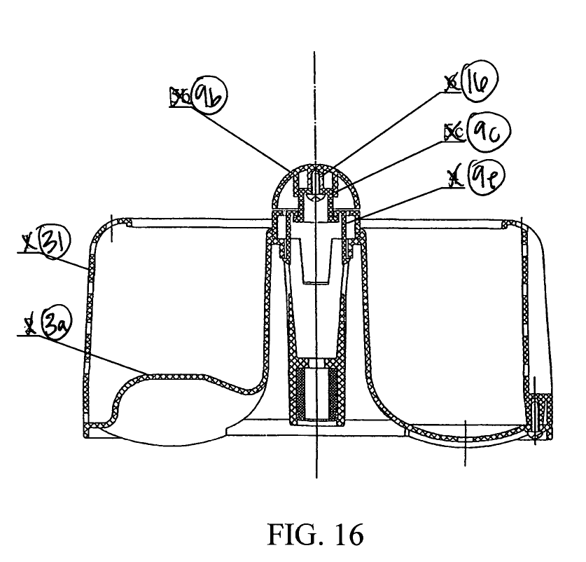

The structure as shown in FIG. 16 is a further variation of the embodiment of the integrated device of the pulsator and the water removal barrel. The present embodiment is similar to the above embodiment except that the supporting body 5b has a hemispherical shape structure and designed as the supporting point.

### INDUSTRIAL APPLICABILITY

The present invention has a lot of advantages in comparison with the prior art as follows. (1) The mop washing machine has a compact and simple structure, smaller size and lower cost by using the integrated device of the pulsator and the water removal barrel. (2) The mop washing machine can be further simplified by integrating the housing and the water tank. (3) The cost can be lowered further by simplifying the supporting means. (4) The good washing effect and the lower consumption of energy can be achieved by using the above structure. As described above, the present invention can provide a mop washing machine with a simple structure, good washing effect and smaller size, which can be used for washing mops in hotels, restaurant, companies, houses, etc.

1-15. cancelled.

16. A machine for washing a mop having a lower supportive head, a cleaning cloth and a handle, comprising
a housing including an upper portion and a lower portion,
a driving mechanism disposed within the lower portion of the housing, including a motor, a transmission mechanism;
a washing barrel, disposed within the upper portion of the housing;
a water removal barrel, disposed within the washing barrel, including a cylinder and a pulsator connected to the cylinder as a base;
a draining mechanism disposed within the lower portion of the housing; and
mop supporting means for supporting the mop, including a protrusion supporting element located at the center of the pulsator, and an upper bracket fixed on the upper end of the housing,
wherein the protrusion supporting element provides a supportive locating point for locating the head of the mop at the upper end thereof, and the upper bracket provides an upper locating element to engage one end of the handle for locating the upper portion of the mop,
wherein when the motor rotates, it drives the pulsator to rotate, and the mop does not rotate relative to the protrusion supportive element, but the cleaning cloth can be driven to contact the inner wall of the water removal barrel.

17. The machine of claim 16, wherein a plurality of water removal holes are provided at the wall of the water removal barrel.

18. The machine of claim 16, wherein the upper bracket has the shape of a door frame, and the upper locating element is disposed at the lower surface of an upper crossbeam of the upper bracket and includes a locating body having a spherical recess provided at the lower end surface thereof, an installation base and a spring, wherein the locating body is of a mushroom shape with a mushroom head having a larger diameter at the lower portion thereof and a shaft having a smaller diameter at the upper portion thereof and being mounted between the installation base and the mushroom head, and the spring encompasses the shaft of the locating body.

19. The machine of claim 17, wherein the upper bracket has the shape of a door frame, and the upper locating element is disposed at the lower surface of an upper crossbeam of the upper bracket and includes a locating body having a spherical recess provided at the lower end surface thereof, an installation base and a spring, wherein the locating body is of a mushroom shape with a mushroom head having a larger diameter at the lower portion thereof and a shaft having a smaller diameter at the upper portion thereof and being mounted between the installation base and the mushroom head, and the spring encompasses the shaft of the locating body.

20. The mop washing machine of claim 16, wherein the upper bracket consists of two openable cover boards that constitute the upper locating element, and a through hole formed at the center of the two cover boards is provided for allowing the handle of mop to pass therethrough.

21. The mop washing machine of claim 17, wherein the upper bracket consists of two openable cover boards that constitute the upper locating element, and a through hole formed at the center of the two cover boards is provided for allowing the handle of mop to pass therethrough.

22. The machine of claim 16, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

23. The machine of claim 17, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

24. The machine of claim 18, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

25. The machine of claim 19, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

26. The machine of claim 20, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

27. The machine of claim 21, wherein the supporting element includes a supporting body, a base and a rotatable element, wherein a lower portion of the supporting body is connected to an upper portion of the rotatable element, the rotatable element is mounted within a rotatable hole at the upper end of the base, and at least two hooks are disposed at the lower end of the base connecting the pulsator.

28. The machine of claim 16, wherein the upper bracket is a triangular-shaped bracket, and the upper locating element has an integral cylindric configuration.

29. The machine of claim 17, wherein the upper bracket is a triangular-shaped bracket, and the upper locating element has an integral cylindric configuration.

30. The machine of claim 17, wherein the speed of the pulsator is at 350-600 rpm, and the water removal barrel has a height of 50-300 mm.

31. The machine of claim 30, wherein the speed of the pulsator is at 400-550 rpm, the water removal barrel has a height of 100-250 mm, and the water removal barrel has a diameter of Φ250-350 mm.

32. The machine of claim 17, wherein the supportive locating point is a combination of a cone and a sphere.

33. The machine of claim 18, wherein the supportive locating point is a combination of a cone and a sphere.

34. The machine of claim 19, wherein the supportive locating point is a combination of a cone and a sphere.

35. The machine of claim 20, wherein the supportive locating point is a combination of a cone and a sphere.
